(19) United States
(12) Patent Application Publication
(10) Pub. No.: US 2018/0089341 A1
(43) Pub. Date: Mar. 29, 2018

(54) Self Equivalence in Hardware Designs

(71) Applicant: Reveal Design Automation, Ann Arbor, MI (US)

(72) Inventors: Akram Baransi, Nazareth (IL); Michael Zajac, Midland, MI (US); Zaher Andraus, San Jose, CA (US)

(21) Appl. No.: 15/831,329

(22) Filed: Dec. 4, 2017

Related U.S. Application Data
(63) Continuation-in-part of application No. 15/256,185, filed on Sep. 2, 2016, now abandoned.
Application No. 15/256,185 is a continuation-in-part of application No. 14/826,105, filed on Aug. 13, 2015.
Application No. 14/826,105 is a continuation of application No. 13/909,747, filed on Jun. 4, 2013, now Pat. No. 9,141,738.
(60) Provisional application No. 62/215,087, filed on Sep. 7, 2015.
(60) Provisional application No. 61/689,347, filed on Jun. 4, 2012.

(51) Int. Cl. G06F 17/50

(52) U.S. Cl. CPC G06F 17/504; G06F 17/5022

(57) ABSTRACT

To verify hardware, identical input values are provided to the first device under test and to the second device under test where the second device under test is logically identical to the first device under test. Output values of the first device under test and the second device under test are compared where both first output values from the first device under test are deterministically predictable from the identical input values and where second output values from the second device under test are deterministically predictable from the identical input values. Differences in the first output values from the second output values indicate incorrect operation.

### CROSS-REFERENCE TO RELATED APPLICATIONS

This application claims the benefit of U.S. Provisional Application No. 61/689,347 filed Jun. 4, 2012. The entire disclosure of the above application is incorporated herein by reference.

### FIELD

The present disclosure relates to automated verification and optimization of complex hardware designs.

### BACKGROUND

Automating and scaling pre-silicon functional verification of state-of-the-art hardware designs, such as microprocessors and microcontrollers, presents many challenges. For example, the use of non-deterministic elements, commonly signified by X, for logic minimization and partial reset of large datapath registers can be effective in reducing the power and area consumption of certain logic in the chip. In certain cases, X's are also inserted to test hypothetical scenarios for improving coverage and other aspects of the design. However, the use of X's introduces verification challenges if not coupled with systematic methodologies and tools that can show that the non-determinism introduced by the X's does not propagate to the outputs of the design.

Sequential X refers herein to the problem of deciding if certain sampling points, including outputs, of an RTL design are deterministic, even with the presence of X's inside the design—referring to detecting the presence of Don't Cares, or X's, on these points. In this disclosure, a formal expression of the Sequential X problem is presented and algorithms which provide varying checking completeness are examined. Reveal-SEQX, an implementation of a Sequential X consistency checker which uses the Reveal model checker and a specialized correctness generator is also described. Further description of the Reveal model checker may be found in Automatic Formal Verification of Control Logic in Hardware Designs, Z. Andraus, Ph.D Dissertation, University of Michigan, April 2009. Reveal-SEQX is applied on a number of publicly available designs to reason about their output Don't Cares. Lastly, it is shown how the methodology and tool are used to avoid “good” X's appearing as false alarms, and to prove that the design is free of output X's.

This section provides background information related to the present disclosure which is not necessarily prior art.

### SUMMARY

This section provides a general summary of the disclosure, and is not a comprehensive disclosure of its full scope or all of its features.

A computer-implemented method is provided for verifying a hardware design for an electronic circuit. The method includes: providing a hardware design description for the electronic circuit; extracting a set of design elements from the hardware design description, where the set of design elements represent the electronic circuit in terms of signals and logical operations performed on the signals and the set of design elements includes deterministic elements having a value selected from zero or one and at least one non-deterministic element having a value denoted by a variable; assigning a first set of values to the deterministic elements of the electronic circuit; checking one or more sample points of the electronic circuit using the first set of values for the deterministic elements and across all possible values for the at least one non-deterministic element; and detecting non-determinism of the non-deterministic element on the one or more sample points of the electronic circuit when two values assigned to the at least one non-deterministic element yields different values at the one or more sampling points.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram illustrating an example method for detecting non-determinism in a hardware design;

FIG. 2 is a diagram further illustrating the example method in which a designer is permitted to mark a register as Safe;

FIG. 3 is a flowchart depicting a general iterative methodology for verifying a hardware design;

FIG. 4 is a flowchart depicting an example method for verifying a hardware design;

FIG. 5 is a flowchart depicting a refined version of the methodology shown in FIG. 3.

FIG. 6 and FIG. 7 shown an illustrative example and a general framework diagram in accordance with an implementation.

### DETAILED DESCRIPTION

Example embodiments will now be described more fully with reference to the accompanying drawings.

First, the behavior of a digital design is formalized using an intuitive notion that represents the design with hardware components reacting to input sequences. The emphasis is on the usage model and methodology rather than rigorous model checking or sequential equivalence checking theories. In a design with non-determinism due to partially initialized registers or the use of X in various forms, the values observed on the outputs are characterized with respect to determinism and whether the correct design description is sufficiently masking the non-determinism from the outputs.

A hardware design can be described as a tuple [symbol] V,INIT,Trans [symbol] , where V=I∪S∪C, and I is the set of input variables, S is the set of state-holding variables, and C is the set of intermediate combinational variables. Each variable is a vector of 1-bit components, and each can take the value of 0 and 1. Thus, the valuations of an n-bit variable belongs to {0, 1}ⁿ. With a fully initialized design and no use of X, the valuations of all the design variables are deterministically dependent on the inputs. Non-determinism is present when some components can take either 0 or 1 even if the inputs are fully specified. In this disclosure, this is referred to as X or Don't Care, interchangeably. A formal verification engine will exhaustively try 0 or 1 in place of the X, in order to determine certain properties. Therefore, the formal analysis is based solely on the {0, 1} domain.

Let [symbol] , [symbol] and [symbol] denote the sets of all possible valuations of S, C and I, respectively. INIT is a subset of [symbol] representing the group of initial states. Trans: [symbol] × [symbol] → [symbol] × [symbol] is a transition function such that (s′,c)=Trans (s, in) where s, in and c are the valuations of S, I and C respectively at the current time frame, and s′ is the valuation of S at the next time frame. We focus in this disclosure on designs with a single clock domain. In such designs, the succession of time frames is defined by the edges of the most frequent clock in the system.

Let M= [symbol] V, INIT, Trans [symbol] be a hardware design. Let (s₁, . . . , sₙ_{ₛ}), (c₁, cₙ_{_{c}}) and (i₁, . . . , iₙ_{ᵢ}) denote the elements of S, C and I respectively. Let profₛ(s,j) return the valuation of sⱼ under s. In other words s= [symbol] profₛ(s,1), . . . , projₛ(s,nₛ) [symbol] . Let proj_{c} and prof_{I} be defined similarly. Let vai_{M} (s, in, v) denote the valuation of the variable v, given that the valuation of S is s, and the valuation of I is in. val_{M} is computed using the proj and Trans functions. Formally,

$${val}_{M} ( s , i n , v ) = \{ \begin{matrix}{proj}_{s} ( s , j ) ; & v = {s}_{j} \\ {proj}_{I} ( i n , j ) ; & v = {i}_{j} \\ {proj}_{c} ( c , j ) ; & v = {c}_{j} , where ( {s}^{′} , c ) = Trans ( s , i n )\end{matrix}$$

Given that, let val_{M}^{k} be a generalization of val that takes into account the time frames of the design. Formally val_{M}^{k} is defined recursively as follows:
val_{M}⁰(s, in, v)=val_{M} (s, in, v)
val_{M}^{k}(s, in₁, in₂, . . . , inₖ₊₁,v)=val_{M}^{k-1}(s′, in₂, . . . , inₖ₊₁,v); where (s′, c)=Trans (s, in₁)
   In words, val_{M}^{k} (s, in₁in₂, . . . , iₖ₊₁,v) is the valuation of the variable v at the current time frame, the input at the current time frame is inₖ₊₁.

Let M= [symbol] V,INIT,Trans [symbol] be a hardware design. Let equal^{k}: INIT²× [symbol] ^{k+1}×(I∪S∪C)→{true, false} be a function defined as equal_{M}^{k} (s₀¹, s₀², in₁, . . . , inₖ₊₁, var)≡val_{M}^{k} (s₀¹, in₁, . . . , inₖ₊₁,var)=val_{M}^{k} (s₀², in₁, . . . , inₖ₊₁ var). If we let O=(o₁, . . . , oₙ_{ₒ}) ε(I∪S∪C)ⁿ^{ₒ} denote the vector of outputs, then equal_{M}^{k} (s₀¹, s₀², in₁, . . . inₖ₊₁, oⱼ) is true for any input sequence and any two initial states if and only if, the input sequence cannot differentiate between the initial states based on the valuation of oⱼ. In many practical cases, a generalized notion of output equivalence is more suitable; each output is “guarded” by a valid bit, which determines whether the value on that output should necessarily be deterministic. In this disclosure, it is assumed, without loss of generality, that each output signal has a valid bit; an output signal without a valid bit can be described as an output signal with a valid bit set to the constant true; for this purpose, val (s, in, true)=true for any sε [symbol] ε and in ε [symbol] . The following generalizes the definitions of value to valid-value which takes into account the valid bit (if invalid, value is assumed to be 0), and of valid-equal to be the analogue of equal. Let [symbol] =(ov₁, . . . , ovₙ_{ₒ})⊂(I∪S∪C∪{true})ⁿ^{ₒ} denote the vector of the valid bits, where ovᵢ is the valid bit of oᵢ.

Let valid—value_{M}^{k} INIT× [symbol] ^{k+1}×(I∪S∪C∪{true})×(I∪S∪C)→{true, false}× [symbol] be defined as follows:

$$valid - {value}_{M}^{k} ( {s}_{0} , i {n}_{1} , … , i {n}_{k + 1} , valid , var ) = {val}_{M}^{k} ( {s}_{0} , i {n}_{1} , … , i {n}_{k + 1} , valid ) , value ; where value = {val}_{M}^{k} ( {s}_{0} , i {n}_{1} , … , i {n}_{k + 1} , valid ) ? {val}_{M}^{k} ( {s}_{0} , i {n}_{1} , … , i {n}_{k + 1} , var ) \text{:} 0$$

Let valid—equal_{M}^{k}: INIT²× [symbol] ^{k+1}×(I∪S∪C∪{true})×(I∪S∪C)→{true, false} be a function such that valid—equal_{M}^{k} (s₀¹, s₀², in₁, . . . , inₖ₊₁, valid, var)=true if and only if valid—value_{M}^{k} (s₀¹, in₁, . . . , inₖ₊₁, valid, var)=valid—value_{M}^{k} (s₀², in₁, . . . , inₖ₊₁, valid, var)

Informally, if the design starts from the initial state s₀¹ or s₀² and gets the input sequence in₁, . . . , inₖ₊₁, the valuation of the valid bit “valid” should be the same, and if so the valuation of the variable “var” is the same as well.

Using this notation, a design with internal non-determinism has no asymptotically observable don't-cares if valid-equal can be established for all design outputs starting at a given time frame. As defined formally in the following definition:
Definition 1. A hardware design M is valid outputs consistent at (after)k₀, denoted by VOutput-Consistent-At (After) (M, k₀), if the following holds for k=k₀ (∀k≧k₀):
   ∀ⱼε{1, . . . , nₒ}, ∀s₀¹, s₀²εINIT, ∀in₁, . . . , inₖ₊₁ε [symbol] :
      valid—equal_{M}^{k}(s₀¹, s₀², in₁, . . . , inₖ₊₁, ovⱼ, oⱼ)
         Informally, a hardware design passes VOutput-Consistent-After (M, k₀), if after getting k≧k₀ inputs, the valuations of the valid bits are not affected by the initial state, and if a valid bit ovᵢ valuation is true, the valuation of oᵢ is not affected by the initial state.

Given a design M= [symbol] V, INIT, Trans [symbol] and k₀, the goal is to determine whether VOutput-Consistent-After (M, k₀) is true. This, in turn, proves that there are not observable don't-cares on the outputs starting at time frame k₀ for the given reset sequence.

This goal is equally applicable for chip-level and block-level descriptions. When performing analysis at the level of the chip, and particularly for microprocessors and micro-controllers, designers are often forced to differentiate between “good” and “bad” don't-cares on the outputs. For example, CPU designs are generally characterized by architectural and non-architectural elements, and a set of specification (ISA) that defines how the processor reacts to executing programs (i.e. their effect on the architectural elements from a programmer viewpoint), and defines environment constrains including legal versus illegal input sequences or programs. If a microprocessor design contains an unintialized architectural element, inconsistency will generally arise; the executing program may read the value of an uninitialized architectural element before writing to it, and in turn introduce an X on the output that would otherwise be absent if the program is legal. This imposes restrictions on the types of don't-cares that are acceptable on the outputs. For this purpose, it is suggested that the following alternative consistency criterion which takes into account the legality of the input.
Definition 2. A hardware design M is legally consistent at (starting from) k₀, denoted by Legally-Consistent-At (After) (M, k₀), if the following holds for k=k₀ (∀k≧k₀):
   ∀jε{1, . . . , nₒ}, ∀s₀¹, s₀²εINIT, ∀in₁, . . . , inₖ₊₁ε [symbol] : legal (in₁, . . . , inₖ₊₁) [symbol] valid—equal_{M}^{k} (s₀¹, s₀², in₁, . . . , inₖ₊₁, ovⱼ, oⱼ)
      Where legal: [symbol] →Boolean returns true if and only if according to the specification of the design behavior the input sequence is well defined and a valid output is expected to react to it. The function legal is usually infeasible to accurately define in a way that allows practical reasoning approaches to yield meaningful results. In the following section, a methodology is presented that allows the user to (partially) define the legality of an input stream either through invariants or properties imposed directly on the input stream or through imposing constraints on the design components that affect the propagation of don't-cares.

An efficient realization of the Sequential X detection system relies on duplicating the design in order to allow simultaneous examination of different assignments to non-deterministic components, while exhaustively examining all possible combinations of the deterministic components that drive values to the circuit (inputs and state initializations). Given a design D that is being checked for X consistency, two instances of the design D₁ and D₂ are created. Across the two instances, components with deterministic values are tied, including inputs and register initialization, while allowing non-determinism for others by leaving them duplicated. A component is marked as “Safe-X” if its corresponding components are tied together so that X originating from them are not leading to violating the consistency check. The following describes the general case where only inputs are marked as Safe.

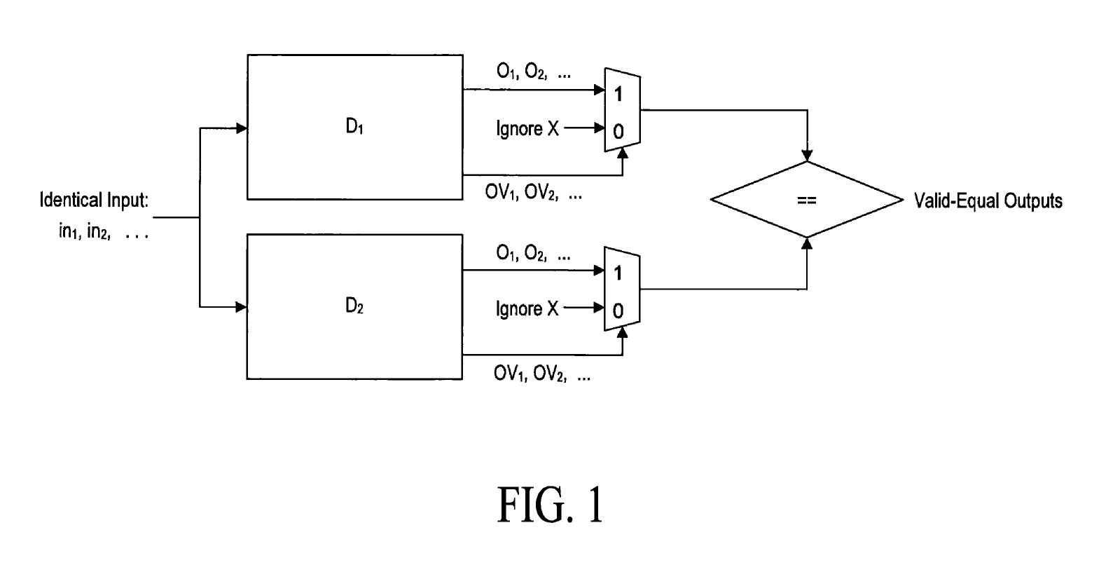

With reference to FIG. 1, the most generic X check allows for a qualifier or valid bit, which indicates when X is allowed. For each observation point oⱼ, with a valid bit ovⱼ, let o¹ⱼ, o²ⱼ be correspond to oⱼ in D₁, D₂, and ov¹ⱼ corresponds to ovⱼ in D₁, then the wire oⱼ_{_}_{consistent}=ov¹ⱼ?(o¹ⱼ==o²ⱼ):1′b1 is used to model the function at the observation point, and the conjunction of all the wires is defined as outputs_consistent= [symbol] ⱼ₌₁^{j=n}^{ₒ} oⱼ_{_}_{consistent}. Checking that outputs_consistent=true indicates that no X is shown on the observable points. This check can be done with any model checker.

Methodology for approximating legal X behavior is further described below. One can use Definition 1 as a first order approximation for the consistency criterion in Definition 2 assuming a tautological “legal” function. In this case, valid-equal will generally fail and return a witness showing an X on the output; in other words, a don't-care originating from an uninitialized element and propagating to the output. Diagnosing this case may determine that it is a “good” don't-care, and as a result there is a need for fixing a bug in the design logic, or ignoring the X showing on the output, or permanently resetting the source state element and paying a certain cost of area and power. Otherwise, this is a “bad” don't-care, i.e., a false alarm originating particularly from architectural elements. To eliminate this, the designer may decide to reset the register for verification purposes, but this may mask bugs that are otherwise present in the original design. Instead, this methodology allows the user to mark the register as “Safe” for X purposes.

The methodology allows the designer to mark an X-generating register as Safe, by checking whether all the outputs are consistent given that the subset S_{safe}⊂S is initialized consistently to a random value. In most practical cases, choosing S_{safe}={uninitialized architectural registers} will prune out “false alarms” in which don't-care values are being propagated from free architectural elements. We will next present the formal definition for this criterion, analyze its relation to the previous criterion, and address its limitations and ways to improve upon it.
Definition 3. A hardware design M is S_{safe} safe X consistent at (starting from)k₀, where S_{safe}⊂S, denoted by Safe-X-Consistent-At (After) (M, k₀, S_{safe}), if the following holds for k=k₀(∀k≧k₀):
   ∀ⱼε{1, . . . , n_{O}}, ∀s₀¹, s₀²εINIT, ∀in₁, . . . , inₖ₊₁ε [symbol] : U A—legal (in₁, . . . , inₖ₊₁) [symbol] [consistent (s₀¹, s₀², S_{safe}) [symbol] O A—legal (in₁, . . . , inₖ₊₁)] [symbol] [symbol] valid—equal_{M}^{k}(s₀¹, s₀², in₁, . . . , inₖ₊, ovⱼ, oⱼ)
      Where consistent is a relation such that consistent (s₀¹, s₀², S_{safe}) [symbol] ∀sⱼεS_{safe}: projₛ(sₒ¹, j)=projₛ (s₀², j), U A—legal is an under-approximation of the function legal (i.e. U A—legal⊂legal), and O A—legal is an over-approximation of the function legal (i.e., legal⊂O A—legal). Under-approximations are usually added by restricting inputs through constant assignment or adding assumptions on a group of inputs or design elements. Over-approximations are usually specified through invariants that were previously proven for the design.

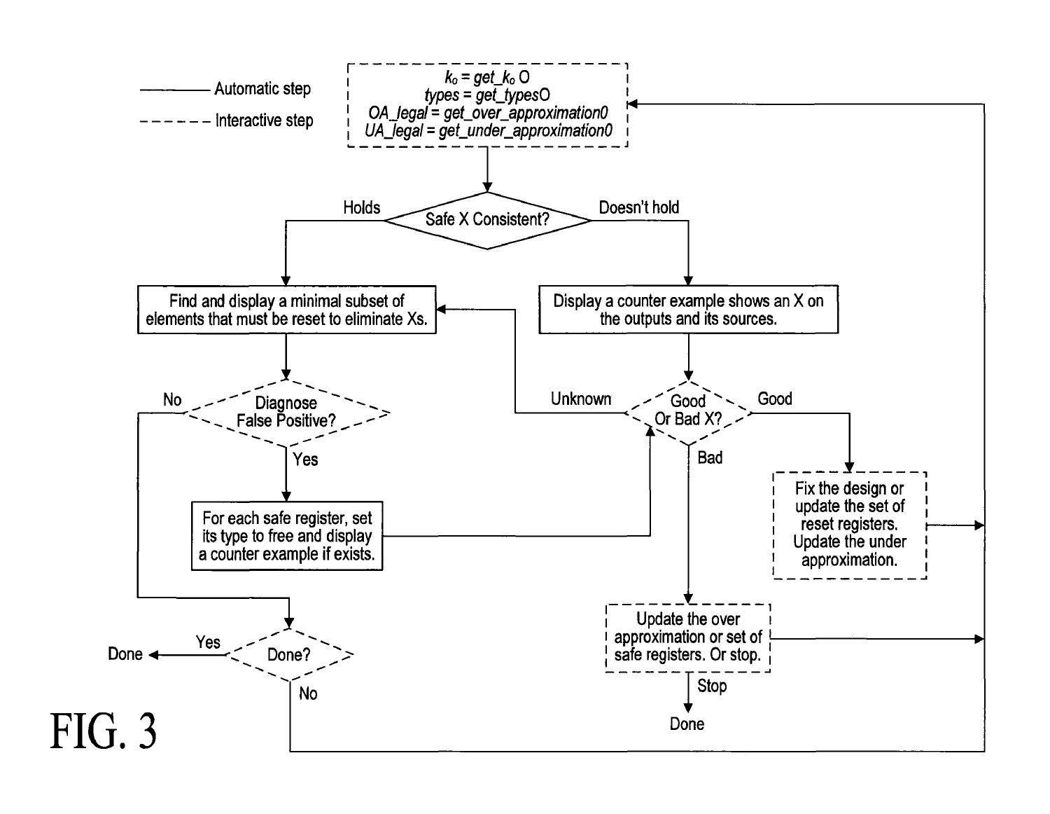

With reference to FIG. 3, an iterative methodology is described in which the designer modifies the design to prune out the false counterexamples by initializing some uninitialized registers or marking them as safe, and tries to minimize the number of reset registers. Assume that each state element sⱼεS has a type tᵢε{free, safe, reset} and sᵣₑₛₑₜεINIT be the reset state. In this case S_{safe} is equivalent to {sⱼεS: tⱼ=safe}. Given the vector t̅, and the reset state sᵣₑₛₑₜεINIT (the state in which the design will be when all the registers are reset), let apply (M= [symbol] V, INIT,Trans [symbol] , sᵣₑₛₑₜ,t̅) be a function that applies the reset values from sᵣₑₛₑₜ onto the state elements. Formally, apply (M= [symbol] V, INIT, Trans [symbol] , sᵣₑₛₑₜ, t̅) returns M′= [symbol] V, INIT′, Trans [symbol] , where INIT′={s₀εINIT|∀j:(tⱼ=reset) [symbol] projₛ (s₀, j)=projₛ (sᵣₑₛₑₜ, j)}.

Given over- and under-approximations of the function legal, the type of each register, and k₀ provided by the user, the design is first checked for consistency via the Safe-X-Consistent-After criterion applied on the design (registers are either reset, marked as safe, or left uninitialized). If the check fails, a counterexample is generated alongside a list of registers that are contributing to the X's showing on the outputs. Based on that and the knowledge about the design, the user can determine whether this is a false alarm involving illegal input or a genuine case indicating a potential bug in the design or lack of reset. The user may then update the type map and the approximations and re-iterate, or invoke an algorithm that computes a minimal set of registers whose reset can eliminate the X from the outputs, which helps in updating the type map and the approximations. The formulation of this process, which is also relevant in the case that the consistency check passes (need to minimize the registers being reset), is explained in the next sub-section. Provided the set S_{safe} that was created incrementally (through interactive work with the tool) or a-priori, and after automatically minimizing the reset subset, the user may want to diagnose the proof for false positives, or minimize the reset subset further based on the design knowledge and input legality. For each Safe register sⱼ the Safe-X proof is re-run after setting tⱼ to free, if no counterexample is found, the register sⱼ should not be in S_{safe}; otherwise, the counterexample is displayed, at which point the user can update the over approximation if the counterexample is “bad”, or fix the design if it is a “good” counterexample.

This methodology provides a framework for an automated Safe X consistency check method. The method also allows over and under approximations to be used to constrain the design behavior. Furthermore, this method enables minimizing the initialization of registers for the purpose of saving area and power, while checking that adding X as a result of non-initialization does not lead to undesired observable X. An example of implementing the third method using the X consistency check is by iteratively and exhaustively un-initializing registers that are initialized in the original circuit, and for each un-initialization combination, the X consistency check is applied. If the proof passes in a given iteration, the register(s) that were purposely un-initialized introduced an X that was not observable on the sample points, and thus can be left without initialization in the original circuit. In other words, the X consistency check is not only a method for validating the current initialization and lack thereof (which introduces X), but also improving the circuit to further introduce safe X values that save area and power.

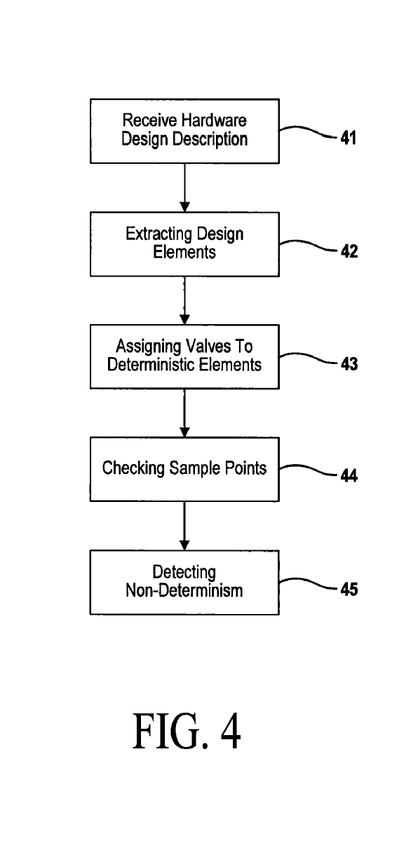

FIG. 4 provides an overview of a computer-implemented method for verifying a hardware design in accordance with this disclosure. In an example embodiment, a hardware design description is provided at 41 for an electronic circuit using a hardware description language, such as Verilog. It is readily understood that other representation of the electronic circuit are contemplated by this disclosure.

A set of design elements is first extracted at 42 from the hardware design description, where the set of design elements represent the electronic circuit in terms of signals and logical operations performed on the signals. For example, design elements may include but are not limited to gates, flip-flops, etc. The set of design elements may include deterministic elements and non-deterministic elements, where a deterministic element has a value selected from zero or one and a non-deterministic element has a value denoted by a variable, such as X. For illustration purposes, a deterministic element may be an initialized register, while a non-deterministic element may be a non-initialized register.

One or more sample points of the electronic circuit are then checked as indicated at 44. Referencing the notation above, VOutput-Consistent-After (M, k_0) can be proven with any model checker. To do so, a first set of values are assigned to each deterministic element of the electronic circuit. The electronic circuit is then checked across all possible values for the non-deterministic elements. For a given non-deterministic element, non-determinism is indicated when two values assigned to the given non-deterministic element yield different values at one or more sampling points. The process may be iterated as necessary (e.g., exhaustively unless prevented by constraints) using a different set of values of the deterministic elements of the circuit. As noted above, this method is not limited to any particular type of model checker.

The remainder of this disclosure describes a more efficient approach that examines non determinism on intermediate points in the design, such as state holding variables. For a given hardware design D that is being checked, two instances of the design D₁, D₂ . . . Dₙ are created. For each state holding variable sⱼ, let s¹ⱼ, s²ⱼ be correspond to sⱼ in D₁, D₂, then the wire sⱼ_{_}_{consistent}=(s¹ⱼ==s²ⱼ) is used to indicate that the state holding variable is consistent, and the conjunction of all the wires is defined as states_consistent= [symbol] ⱼ₌₁^{j=n}^{ₒ} sⱼ_{_}_{consistent}. Algorithm 1 shows how this is done using an auxiliary method that checks states_consistent starting at a given cycle k₀.

An example of an improved implementation given in Algorithm 2 borrows the concept of “valid bits” to state elements, such that sⱼ_{_}_{consistent}==s²ⱼ):1′b1. The logic representation of the valid bits is dependent on the circuit at hand. The algorithm uses an inductive argument based on the valid bits as a way to temporally abstract the behavior of the design with respect to non-determinism in the registers. The variation given in Algorithm 3 describes the case where valid bits are used in conjunction with marking registers as Safe-X.
Definition 4. A hardware design M is state consistent at k′, denoted by State-Consistent-At (M, k′), if the following holds for k=k′:
   ∀s₀¹, s₀²εINIT, ∀in₁, . . . , inₖ₊ᵢε [symbol] , ∀jε{1, . . . , nₛ}: val_{M}^{k}(s₀¹, in₁, . . . , inₖ₊₁, sⱼ)=val_{M}^{k}(s₀², in₁, . . . , inₖ₊₁, sⱼ)
      Informally, if we start from any initial state and get any k₀ inputs, the valuation of S will be independent of the initial state.
      Assertion 1. ∀kε [symbol] : State-Consistent-At (M, k) [symbol] VOUTPUT—Consistent—At (M, k)

### Assertion 2.

((∀kε{k₀, k₀+1, . . . , k′} VOutput-Consistent-At (M, k)) [symbol] State-Consistent-At (M, k′)) [symbol] VOutput-Consistent-After (M, k₀)
The following algorithm is based on assertions (1) and (2), which can be shown trivially. It attempts to find a pivotal k′ that satisfies assertion (2). If the algorithm is unable to find such a k′, it will attempt to prove that ∀kε{k₀, k₀+1, . . . , kₘₐₓ}: VOutput-Consistent-At (M, k), where, kₘₐₓ is a given parameter.

Algorithm 1

```
For k′ ← k₀ to kₘₐₓ
  If (! (VOutput-Consistent-At (M, k′)))
    print “The design is not consistent starting from k₀”
    return 0
  If (State-Consistent-At (M, k′))
    print “The design is consistent starting from k₀”
    return 1
print “The design is consistent ∀k ϵ {k₀, k₀ + 1, ... , kₘₐₓ}”.
return 2
```

Algorithm 1 passes on two illustrative examples as will be described below. On real-life designs, however, a modified version of Algorithm 1 was used in order to achieve a proof with unbounded depth. Similarly to the outputs, it uses “valid bits” for the state-holding variables, and attempts to prove an invariant on the state-holding variables that can lead to convergence on verifying the property. Note also that Algorithm 1 assumed no X on inputs or wires. Algorithms 2 and 3 below make no such assumptions.

Without loss of generality, assume that each state-holding variable has a valid bit. Let SV=(sv₁, . . . , svₙₛ)⊂(I∪S∪C∪{true})ⁿ^{ₛ} denote the vector of the valid bits, where svᵢ is the valid bit of

Definition 5. A hardware design M is valid states consistent at k′, denoted by VState-Consistent-At (M, k′), if the following holds for k=k′:
∀s₀¹, s₀²εINIT, ∀in₁, . . . , inₖ₊₁ε [symbol] , ∀jε{1, . . . , nₛ}
valid—equal_{M}^{k}(s₀¹, s₀², in₁, . . . , inₖ₊₁, svⱼ, sⱼ)

Definition 6. A hardware design M satisfies the Valid state consistent invariant, denoted by VState-Consistent-Invariant (M), if the following holds ∀\hat{k}ε [symbol] :
(Vstate-Consistent-At (M, \hat{k})) [symbol] (VState-Consistent-At (M, \hat{k}+1))

Definition 7. A hardware design M satisfies the unobservable X invariant, denoted by Unobservable-X-Invariant (M), if the following holds ∀\hat{k}ε [symbol] :
(VState-Consistent-At (M, \hat{k})) [symbol] (VOutput-Consistent-At (M, \hat{k}))

Definition 8. A hardware design M is inductively consistent, denoted by IC (M), if the following holds:
(VState-Consistent-Invariant (M) [symbol] Unobservable-X-Invariant (M)

### Assertion 3.

((∀kε{k₀, k₀+1, . . . , k′}: VOutput-Consistent-At(M, k)) [symbol] VState-Consistent-At (M, k┘) [symbol] IC (M)) [symbol] VOutput-Consistent-After (M, k₀)
The following algorithm is based on assertion (3), which can be shown trivially. It attempts to find a pivotal k′ such that VState-Consistent-At (M, k′) holds. If such a k′ is found, and IC (M) holds, then the design is consistent starting from k₀. Otherwise, it will attempt to prove that ∀kε{k₀, k₀+1, . . . , kₘₐₓ}: VOutput-Consistent-At (M, k), where kₘₐₓ is a given parameter.

Algorithm 2 VOutput-Consistent-After-Test (M, k₀, kₘₐₓ)

| | |
|---|---|
| (01) | k′ ← k₀ |
| (02) | While (k′ ≤ kmax) |
| (03) | If (!( VOutput-Consistent-At (M, k'))) |
| (04) | print “The design is not consistent starting from k₀” |
| (05) | return 0 |
| (06) | If ( VState-Consistent-At (M, k′)) |
| (07) | break |
| (08) | k′ ← k′ + 1 |
| (09) | If(k′ ≤ kₘₐₓ && IC (M)) |
| (10) | print “The design is consistent starting from k₀” |
| (11) | return 1 |
| (12) | While ((k′ ≤ kₘₐₓ) |
| (13) | If (! (VOutput-Consistent-At (M, k′))) |
| (14) | print “The design is not consistent starting from k₀” |
| (15) | return 0 |
| (16) | k′ ← k′ + 1 |
| (17) | print “The design is consistent ∀k ϵ {k₀, k₀ + 1, ... , kₘₐₓ}”. |
| (18) | return 2 |

Without loss of generality, in what follows we will extend the previous algorithms for the cluster of designs that are “consistently initialized”, as defined below, for the purpose of safe-X.

Definition 9. Let M be a hardware design. sⱼ is a consistently initialized state—holding variable, denoted by Consistently-Initialized-Variable (M, sⱼ) if the following holds:
∀s₀¹, s₀²εINIT:projₛ(s₀¹, j)=projₛ(s₀², j)
   Informally, sⱼ is a consistently initialized state—holding variable, if its valuations in all of the initial states are the same.

Definition 10. Let M be a hardware design. sⱼ is a free—state holding variable, denoted by Free-Variable (M, sⱼ), if INIT is closed under changes in the value of sⱼ, Formally:
∀s₀¹εE INIT, ∀yε [symbol] ⱼ, ∃s₀²εINIT: projₛ(s₀², j)=y [symbol] [symbol] ∀lε{1, . . . , nₛ}\{j}:projₛ(s₀¹, l)=projₛ(s₀², l)
   Where [symbol] ⱼ denotes the set of all possible valuations of sⱼ.

Here is an example illustrating Definitions 9 and 10:

reg s₁,s₂,s₃, flag;
initial begin

| | |
|---|---|
| s₁ = 0; | //s₁ is consistently initialized. |
| | //s₂ is free. |
| if (flag)s₃ = 0; | //s₃ and flag are neither consistently initialized nor free. |
| end | |

Definition 11. Let M be a hardware design. M is consistently initialized, denoted by Consistently-Initialized (M), if the following holds:
∀sⱼεS: Consistently-Initialized-Variable (M, sⱼ) [symbol] (M, sⱼ) [symbol] Free—Variable (M, sⱼ)

Denote the set of all the free state-holding architectural variables of a microprocessor design CPU by [symbol] . Formally [symbol] ={sⱼεS∩R: Free-Variable (CPU, sⱼ)}. Let [symbol] denote the set of all possible valuations to the set [symbol] . While reference is made to a microprocessor, it is understood that the concept described herein are not limited thereto and is applicable to any hardware design or portions thereof

Let the function reg-map (CPU, fr), where CPU= [symbol] V, INIT,Trans [symbol] is a microprocessor design, and frε [symbol] , return CPU′= [symbol] V, INIT′, Trans [symbol] , where INIT′={s₀εINIT|the valuation of [symbol] in s₀ is fr}.

Assertion 4. Safe-X-Consistent-After (CPU, k₀) [symbol] ∀frε [symbol] :Consistent-After (reg-map (CPU, fr), k₀).

The RHS of assertion 4 can be checked by applying algorithm 2 with the reg-map option of reveal for an arbitrary fr₀ε [symbol] .

Algorithm 3 Safe-X-Consistent-After-Test (M, k₀, kₘₐₓ)

```
Results = {VOutput-Consistent-After-Test (reg-map (CPU, fr), k₀, kₘₐₓ)|fr [symbol]    }
If (0 ϵ Results)
  print “The design is not consistent starting from k₀”
  return 0
If (2 ϵ Results)
  print “The design is consistent ∀k ϵ {k₀, k₀ + 1, ... , kₘₐₓ}”.
  return 2
print “The design is consistent starting from k₀”
return 1
```

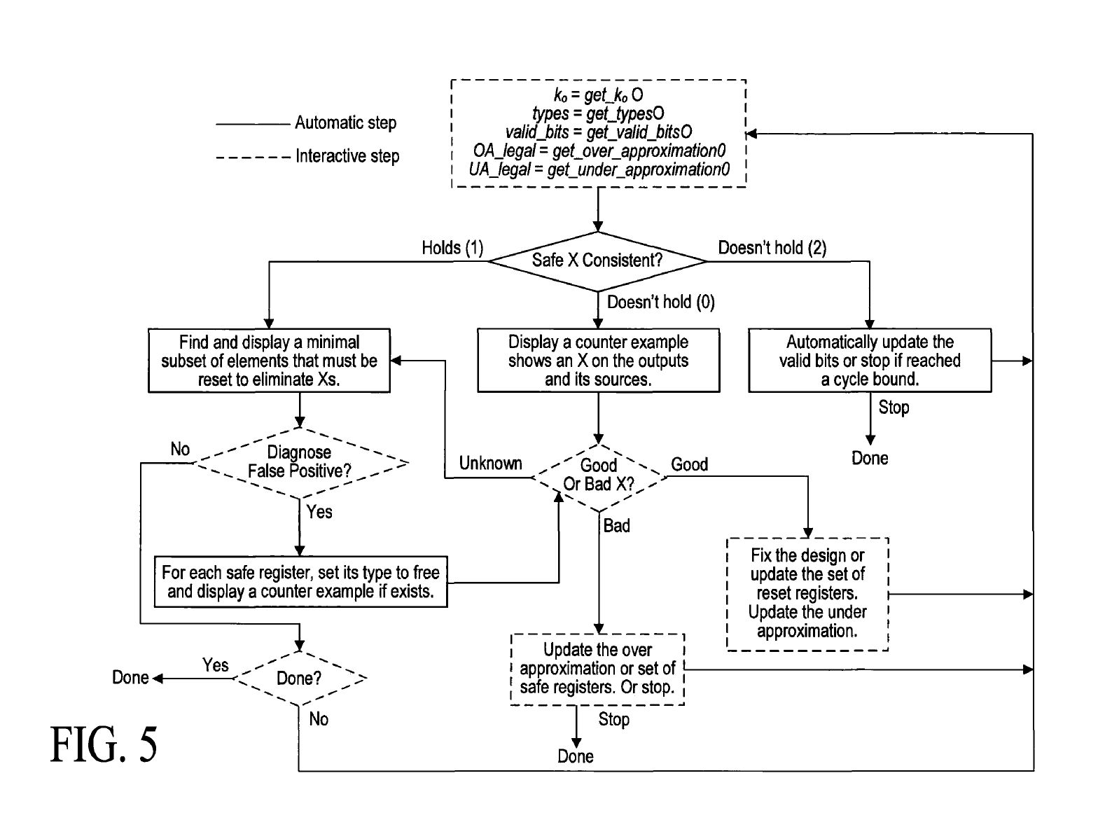

The methodology described in FIG. 5 refines the one shown in FIG. 3 based on Algorithm 3. The Safe-X-Consistent-After now results in either successfully proving the property, or failing due to two possible reasons; failure due to a legitimate counterexample, or failure due to a negative result in the induction (in which case Reveal-SEQX reports success for bounded equivalence with kₘₐₓ). The rest of the flow is similar in the earlier case, while in the latter, an automatic algorithm can be used to update the valid bits.

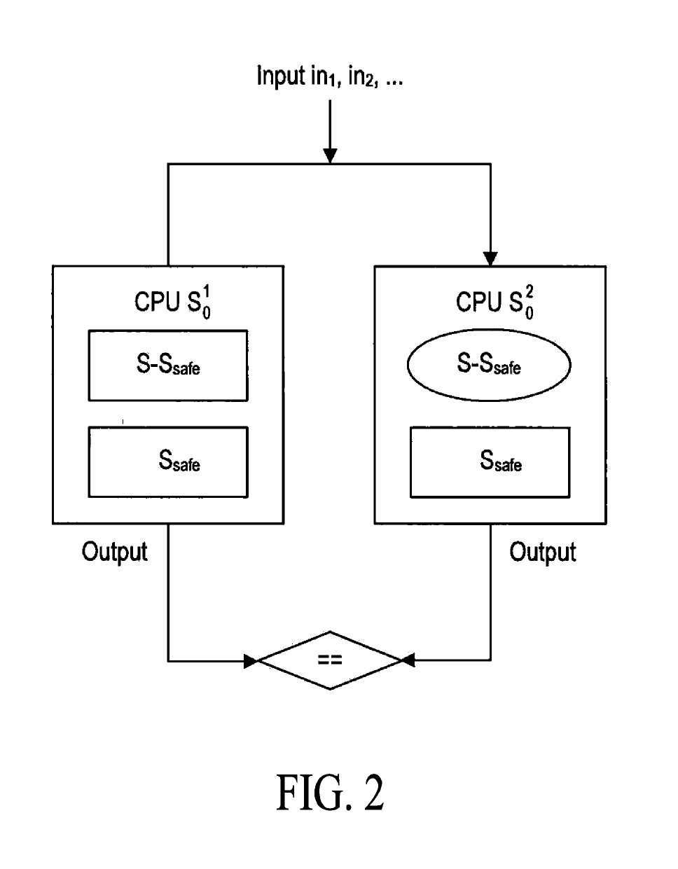

The Reveal-SEQX application integrates an implementation of Algorithm 3 and the Reveal model checker, based on the configuration in FIG. 2. The algorithm was run on a 64-bit Alpha processor, a 5-stage pipeline where much of the internal state is reset. The design is intended to have a register file attached to inputs and outputs of the core, but due to the nature of the Sequential X algorithm, we did not need to supply a safe-x list. The design is Safe-X consistent with k₀=4 and an empty S_{safe}. It also has been applied on a publicly available MIPS core, which is also a 5-stage pipeline, and contains 1615 single-bit registers, with S_{safe} consisting of the architectural memories and the registers file. The run time for these examples on a machine with Intel Core i7 CPU 860 at 2.80 GHz and 8 GB memory is seconds to show a witness for an X bug, and minutes for a full proof.

Below is set out first a summary of techniques and circuitry for verifying hardware using self-equivalence. Then follows additional explanation further describing the techniques and circuitry required.

For example, hardware can be verified by providing a first device under test and providing a second device under test. The first device under test is logically identical to the first device under test. A determination is made as to which output values from the first device under test are deterministically predictable based upon input values to the first device under test without knowing an initialization state of the first device under test. Likewise, it is determined which output values from the second device under test are deterministically predictable based upon input values to the second device under test without knowing an initialization state of the second device under test. Identical input values are provided to the first device under test and to the second device under test. First output values of the first device under test are compared with first output values of the second device under test. The first output values from the first device under test are deterministically predictable from the identical input values and the second output values from the second device under test are deterministically predictable from the identical input values. Differences in the first output values from the second output values indicate incorrect operation

For example, logic implementing the first device under test is identical to logic implementing the second device under test. For example, the logic implementing the first device under test is identical in function to logic implementing the second device under test, but is configured so that there are timing differences between the first device under test and the second device under test. For example, the timing differences arise are caused by activation or deactivation of one or more of the following functionalities: pipelining, caching, queuing, power optimizations, dynamically controlled power optimizations, parallelism in data fetching, parallelism in processing, parallelism in resource sharing, or some other feature or combination of features that changes timing but not function of the logic.

For example, “don't care” states may be added to the input values to one or both of the first device under test and the second device under test. That is, additional input values to the first device under test are provided that are not identical to additional input values to the second device under test. The additional input values to the first device under test and the additional input values to the second device under test are in addition to the identical input values provided to the first device under test and to the second device under test.

For example, the logic implementing the first device under test is implemented using hardware devices fabricated on an integrated circuit chip. Alternatively, the logic implementing the first device under test is implemented by an emulator. Alternatively, the logic implementing the first device under test is implemented by software running on a computing device.

For example, the identical input values to the first device are chosen based on expected input to the first device under test during normal operation. Alternatively, the identical input values to the first device are chosen based on providing a formal proof of correct operation.

Instead of hardware, a software design can also be tested. For example,

a first software-implemented device under test and providing a second software-implemented device under test are provided. The first software-implemented device under test is logically identical to the first software-implemented device under test. A determination is made as to which output values from the first software-implemented device under test are deterministically predictable based upon input values to the first software-implemented device under test without knowing an initialization state of the first software-implemented device under test. Likewise, it is determined which output values from the second software-implemented device under test are deterministically predictable based upon input values to the second software-implemented device under test without knowing an initialization state of the second software-implemented device under test. Identical input values are provided to the first software-implemented device under test and to the second software-implemented device under test. First output values of the first software-implemented device under test are compared with first output values of the second software-implemented device under test. The first output values from the first software-implemented device under test are deterministically predictable from the identical input values and the second output values from the second software-implemented device under test are deterministically predictable from the identical input values. Differences in the first output values from the second output values indicate incorrect operation

Further illustrations are given in the sections below.

As set out above in Definition 2. A hardware design M is valid, outputs consistent at (after) k₀, denoted by V_Output-Consistent-At (After) (M, k₀), if the following holds for k=k₀(∀k≧k₀):
∀jε{1, . . . , nₒ}, ∀s₀¹, s₀²εINIT, ∀in₁, . . . , inₖ₊₁εI:
valid—equal_{M}^{k}(s₀¹, s₀², in₁, . . . , inₖ₊₁, ovⱼ, oⱼ)

Section 1: Examples of Self-Equivalence Criteria:

This section reviews examples of implementing the criterion set out in Definition 2 above using logic models that can be diagnosed via a hardware circuit or a computer simulation of a hardware circuit and proving the criterion. That is, as set out above in Definition 2, a hardware design M is valid, outputs consistent at (after) k₀, denoted by V_Output-Consistent-At (After) (M, k₀), if the following holds for k=k₀(∀k≧k₀):
∀jε{1, . . . , nₒ},∀s₀¹, s₀²εINIT, ∀in₁, . . . , inₖ₊₁εI:
valid—equal_{M}^{k}(s₀¹, s₀², in₁, . . . , inₖ₊₁, ovⱼ, oⱼ)

A first example involves straightforward comparison of output values for the purpose, among others, of validating X behavior. The second example involves comparing output values while incorporating design information that qualify values. This latter example is illustrated through two applications, wherein the choice of qualifiers determines additional parameters in the given correctness criterion.

These criteria are characterized by simplicity and brevity of what the user of the system providers, as will be showcased below.

To define the various examples, the equivalence relation for the set of functions is specified as

INIT²×I^{k+1}×(I∪S∪C∪(true))×(I∪S∪C∪)→{true false} in Definition 2. Given two functions F₁, F₂: I*→I*, the equivalence class partition the values such that two values belong to the same class if and only if
valid—value_{M}^{|F}^{₁}^{(in)|}(s₀¹, F₁(in), valid, var) has an equal value to
valid—value_{M}^{|F}^{₂}^{(in)|}(s₀, F₂ (in), valid, var) for all possible input values, where
in=in₁, . . . , inₖ₊₁, and |Fᵢ(in)| is the length of the inputs vector returned by Fᵢ(in). In other words, the result will be true if and only if starting from the initial state s₀¹, and apply the input sequence F₁(in), or starting from s₀² apply the input sequence F₂(in) cannot be observed on the output var.

By varying the functions F₁ and F₂, the equivalence class is determined, and in turn the type of Equivalence Criterion is chosen.

Subsection 1.1: Qualification Free Equivalence

The most simplified case is defined by choosing F₁=F₂=I (The identify function) in V_Output-Consistent-After (M, k₀), and ∀i:ovᵢ=true. This case represents qualification-free self-equivalence. If V_Output-Consistent-After (M, k₀) is true under this case, the two copies of the design have no observable differences on the outputs at/starting at k₀, indicating that there are no X's on the output of the design for the given reset sequence, provided that inputs are also qualification free, as described above.

Subsection 1.2: Qualified Equivalence

Three examples of qualified equivalence are given in this section.

Subsection 1.2.1: Qualify Outputs

If F₁=F₂=I, and ovⱼ is any signal in the design, i.e. not always true, then this will represent the case in which the outputs are tested for differences under some conditions. Applications for this example are also additionally described above.

Subsection 1.2.2: Qualify Outputs and Qualify Inputs by Allowing Xs

Some designs are supposed to sample part of their inputs only in a subset of the scenarios, for example, if the design has an input i and an input vᵢ such that vᵢ is a valid bit for i, or in other words v indicates when the value of vᵢ is valid, then changing the value of i when vᵢ is not active should not affect the outputs of the design. This feature can be easily tested using the self-equivalence approach by letting the function F₂ replace i with an X when vᵢ is not active, and F₁=I.

Subsection 1.2.3: Qualify Outputs and Qualify Inputs by Allowing Timing Differences

Let the function F₂ provide a different input sequence that is supposed to give the same output as the original sequence. For example, given a design that takes an input i, and it is supposed to do nothing when i=NOP, then let F₁=I, and F₂ (in₁, in₂ . . . , inₖ)=in₁, NOP, NOP, in₂, NOP, NOP in₃ . . . , NOP, NOP, inₖ. In other words, F₂ gives the design more time to handle an input before getting the next one, while the expected final result should not be affected. In this scenario, multiple kinds of control and optimization bugs can be exposed, such as bugs in pipelining, caching, queuing, X-related power optimizations, dynamically controlled power optimizations, and parallelism in data fetching or processing or resource sharing.

Section 2: Leveraging Automatic Formulations for Hardware Design

The previous section described various examples of leveraging the correctness comparison in Definition 2, in formulating relations on the design elements. This section explains examples of leveraging those towards creating meaningful and tangible results.

Subsection 2.1: In Simulation

The first utilization is applying drivers that push stimuli values on the inputs of the two copies of the design, and checking whether the equivalence holds. This is a direct application of the correctness criterion in verification using Simulation, also referred to as Functional Verification. A simulator will process the design written in Verilog or C or any chip design or software design language, and will apply those values and calculate the value of the comparison over clock ticks or any other notion of time or progression. In this application, an existing verification environment that was previously written with or without user-defined assertions, can be leveraged to verify the new criteria given by Definition 2.

Subsection 2.2: In Formal

The second utilization, which is related, is using exhaustive proof or analysis algorithms, to automatically compute drivers that violate the given criterion. This is a direct application of the correctness criterion in verification using Formal Verification. A formal tool will process the design written in Verilog or C or any chip design or software design language, and will compute value sequences over clock times or equivalent notion, that will violate the comparison, or prove that none exists.

For example, the behavior of a digital design is formalized using an intuitive notion that represents the design with hardware components reacting to input sequences. The emphasis is on the usage model and methodology rather than rigorous model checking or sequential equivalence checking theories. In a design with non-determinism due to partially initialized registers or the use of X in various forms, the values observed on the outputs are characterized with respect to determinism and whether the correct design description is sufficiently masking the non-determinism from the outputs.

Subsection 2.3: In Property Generation

In the previous two examples, the criterion in Definition 2 is implicit in the comparison or the software representation in memory of the corresponding relations in the design. In a third utilization, the criterion is generated explicitly via an Assertion, which can be fed to a Simulation or Formal tools that perform the check independently. This allows the method to be used for automatic generation of Simulation assertions or Formal properties. While designers and engineers manually write initial assertions or properties and assess their coverage, said method can help automate this process for additional assertions/properties, or even the creation of those from scratch without having the designer or verification engineer seed the system with no initial properties/assertions at all.

Subsection 2.4: In Improving Functional Coverage

In a fourth utilization, incrementally improving functional coverage is achieved and documented, with applying more and more sophisticated variations as given in subsection 1.1 and subsection 1.2.

Qualification-free Equivalence given in subsection 1.1 represents the weakest, albeit useful, formulation of correctness, wherein design sample points are supposed to be deterministic and X free.

Strongest functional coverage is achieved using the formulation in subsection 1.2.1, in which the design outputs are consistent with the specifications (including documents) in terms of readiness of output values. A design that is not consistent with this will require further debug and analysis, and will obviously not meet stricter definitions of functional correctness.

To further strengthen the functional coverage, designers can apply the formulation in subsection 1.2.2, in which inputs are allowed to have non-default qualifiers.

Significantly stronger coverage is achieved through the formulation in subsection 1.2.3. Designs passing this criterion, will be characterized by correct control logic for dealing with complex sequences. Such control logic may implement pipelining, caching, queueing, X-related power optimizations, parallelism, or other Reference Independent Optimizations (RIOs) used for improving power, area, and performance. The use of this criterion in software verification is also possible, for showing the parallelism produces the same result as a monolithic non-parallel system.

Note that in this fourth utilization, the result of one stage can be used in the following (or other) stage. For example, qualification can be passed through the next stage, after being vetted in the previous stage.

Subsection 2.5: In a Comprehensive Methodology

The qualified design in Definition 2 represents a simplified version that strips away complex functionality related to the RIOs. It can therefore be used to relate the design to an independent reference. Therefore, rather than simulating the original design, or proving properties on it, or related it to the reference, verification can be done in two stages: using self-equivalence, and using equivalence between the qualified design and the independent reference. This separation enables two clear types of functional coverage to be assessed—functional coverage for RIOs, and functional coverage for basic functionality. It also allows leveraging automated abstraction methods in the self-equivalence stage, wherein data path elements are identical in the two designs, and can be automatically and safely abstracted for the purpose of verifying RIOs. This leads to significant improvement to scalability of exhaustive proof-based verification.

Section 3: Illustrative Example

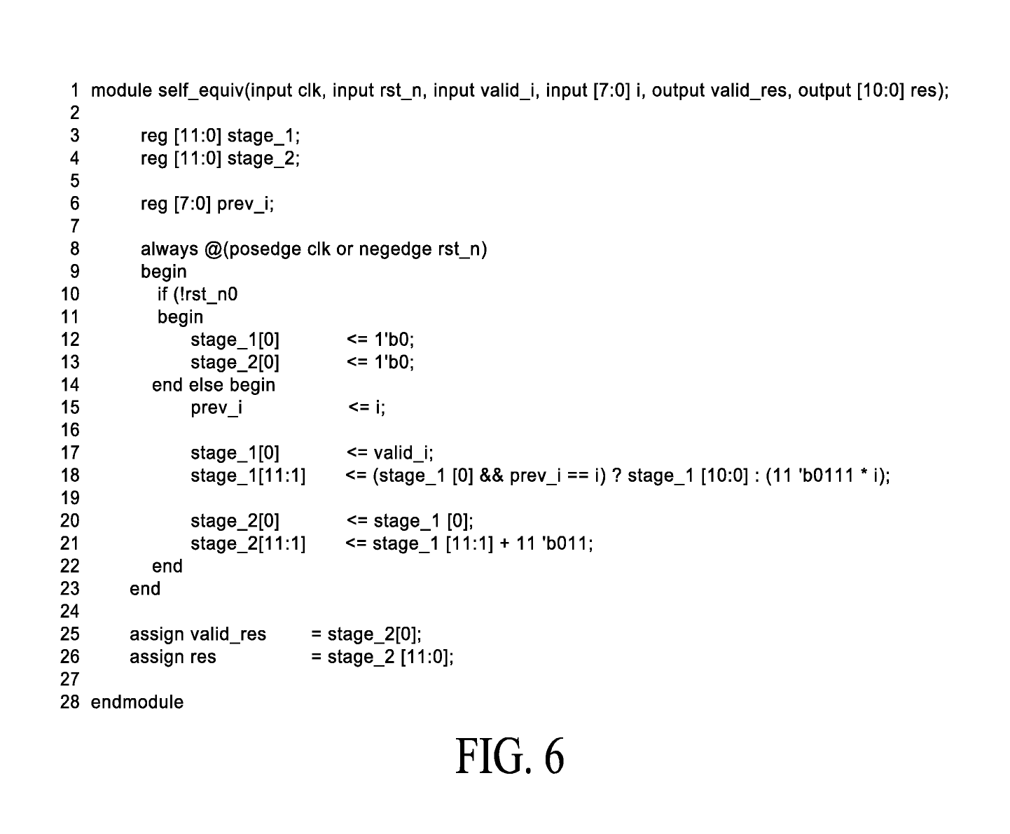

In this section is illustrated the different self-equivalence criteria on the simple design shown in FIG. 6. The design takes two inputs, valid_i and i, and returns two outputs valid_res and res, the input i is multiplied by 7 in the first stage, then a three is added to the result in the second stage before it goes to the output res. Note that at line 18 the design checks if the previous input prev_i was valid and it is equal to the current input i, if that is the case then the design is supposed to use the previous result instead, but there is a bug in the extract, stage_1[10:0] should be replaced with stage_1[11:1] to fix the bug. This bug can be exposed by choosing the correct F₁ and F₂.

Subsection 3.1: Qualification Free Equivalence

If run without qualifiers, as described in subsection 1.1, a counter example will be produced, because stage_2[10:0] does not have a reset, thus the output res will have Xs. This is a false counterexample, because the output res should not be checked when valid_res is low.

Subsection 3.2: Qualify Outputs

To prevent the previous false counterexample, the criterion described in subsection 1.2.1, is used, i.e. the signal valid_res is used as the valid bit of the output res, and the proof will pass.

Subsection 3.3: Qualify Outputs and Qualify Inputs by Allowing Xs

The value of the input i should not affect the outputs when valid_i is low, thus if the criterion described in subsection 1.2.2 is used, the function F₂ replaces the input i with X when valid_i is low, and the proof will pass as well.

Subsection 3.4: Qualify Outputs and Qualify Inputs by Allowing Timing Differences

The output of the design should not be affected if an invalid input is inserted between every two in-puts, in other words, if F₁=I and

F₂ (in₁, in₂, . . . , inₖ)=in₁, NOP, in₂, NOP, in₃ . . . , NOP, inₖ, where inⱼ is the pair (iⱼ′, valid_iⱼ), and NOP=(X; 1′b0). While setting the valid bit of the output res to valid_res as in the previous runs, the proof will fail with a real counter example that exposes the bug at line 18.

The rest of this subsection describes an exemplar general frame work, which enables duplicating the design, and modifying the input sequence to test pipelining, queues, and parallelism—three common control optimizations used for improving performance.

Subsection 3.4.1: Example A—Pipelining

In this example, “Empty transactions”, equivalent to NOPs in processors, are added to create delays between transactions, in order to test pipelining and queues. Accordingly, the formulation takes into account (a) sampling at the correct time, and (b) incorporating the X qualifiers to allow meaningful results. While the user defines who the delays are inserted, this subsection describes how the sampling and incorporating of X qualifiers are done automatically, to allow the method to scale to large designs.

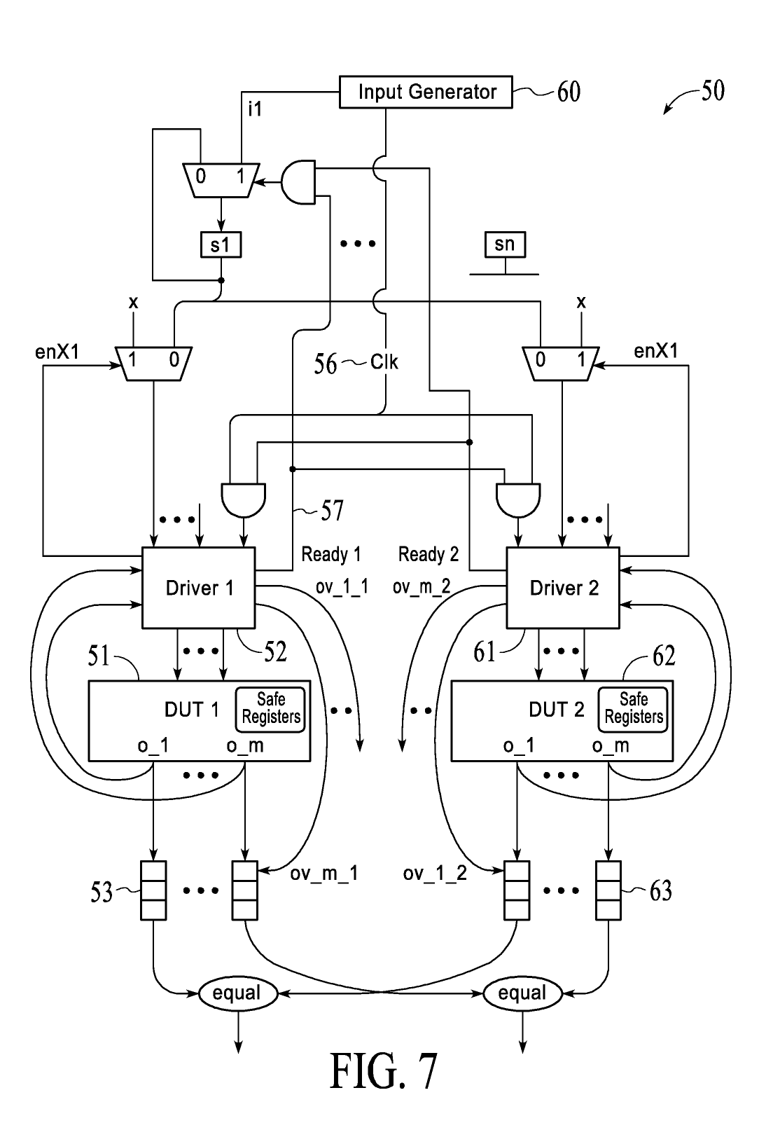

The general framework is shown in FIG. 7. One instantiation includes a device under test (DUT) 51 and drivers 52. Another instantiation includes a DUT 61 and drivers 62. First-in-first-out memories (FIFOs) 53 receive output from DUT 51. There is one FIFO for each of N outputs of DUT 51. Likewise, FIFOs 63 receive output from DUT 61.

There is one FIFO for each of N outputs of DUT 61. Input circuitry generates and synchronizes inputs to drivers 52 and drivers 62. Driver 52 receive as inputs all the outputs of DUT 51 in addition to a gated clock 56 from an inputs generator 60. Driver 43 outputs a valid bit ovⱼ for each output oⱼ of DUT 51, and a special output 57 called ready, which indicates that driver 51 is ready to take a new input from inputs generator 60 and send it, possibly with some modifications, to DUT 51.

For each input of the DUT iⱼ, inputs generator 60 has a corresponding input iⱼ^{g} and a state-holding variable (register) sⱼ^{g}, the register sⱼ^{g} is not initialized and its value is updated to iⱼ^{g} at every cycle on which both drivers are ready. In some scenarios, some of the inputs should not affect the outputs of the DUT, or the results produced by it, for example, assume a design with one input called “in” and another input called “valid_in”, and assume that the design is supposed to use the value of “in” only when “valid_in” is true, in this case, every time “valid_in” is false, the valuation of “in” should not affect the design, thus one can assign the value X to the input “in”, formally for each input iⱼ the input generator holds a variable enXⱼ that enables X s on the input iⱼ, in other words, when Xenⱼ is true the input i_{f} is allowed to get different values on the two copies of the DUT, otherwise the two copies will get the same value from the input generator. Denote by iⱼ¹ the input iⱼ of the first driver, iⱼ¹ will be connected to a mux mⱼ¹ that is controlled by Xenⱼ, and outputs sⱼ^{g} when Xenⱼ is false and X when Xenⱼ is true, similarly iⱼ² of the second driver will be connected to the output of the mux mⱼ².

In addition, for each output oⱼ of the DUT, each driver holds a valid bit ovⱼ, when the valid bit in the first driver ovⱼ¹ is high, the output ovⱼ¹ will be inserted into the FIFO Fⱼ¹, similarly the second driver inserts 0ⱼ² to Fⱼ² when ovⱼ² is high. If both FIFOs are not empty the top of the first FIFO will be compared to the top of the second FIFO, and if they are not equal a counter example will be displayed to the user, otherwise the top will be removed from the two FIFOs.

Note that one driver might be much faster than the other, and a long FIFO will be needed to store all the outputs, to prevent such a scenario the ready flag of one driver is used as a gate for the second driver's clock, i.e. if one driver is ready and the other is not, the ready driver will be blocked. By using this technique, the fast driver will be blocked until the slower driver is ready, thus it will not be able to produce too much results and a finite small FIFO will be enough.

Here also the user may need to mark some of the registers as safe X to prune out false alarms, i.e. the user may want to assume that some of the registers are initialized to the same values in both copies of the DUT.

Subsection 3.4.2: Other Examples of Optimizations

X-related power/area optimizations: Xs are used to optimize the power and the area of the chip, however, a wrong use of the Xs might affect the design correctness, and it can be exposed by running a self-equivalence using the algorithms described in section 2 of Akram Baransi, Michael Zajac and Zaher Andraus “Sequential X Detection in Hardware Designs”, Reveal Design Automation, Inc., June 2012.

Caching: Caches do not affect the correctness of the design, they are used just to improve the performance. Thus, a self-equivalence between the design and itself can be ran where in one copy the cash is enabled and disabled in the other. And this will expose bugs in the cache if it is buggy.

Power Optimizations: Similarly, to the cashing, the power optimizations, such as clock gating, should not affect the correctness of the design. Thus, the design can be tested against itself with the power optimizations enabled in one copy and disabled in the other to expose bugs.

Parallelism: A design that handles K requests at every cycle, can be ran in a slower mode in which it handles a single request at every cycle and it is supposed to give the same results.

Baud Rate: in communication channels, the same data can be transmitted in different baud rates to expose bugs that affect one rate but not the other.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for verifying hardware, comprising:
providing a first device under test;
providing a second device under test, the second device under test being logically identical to the first device under test;
determining which output values from the first device under test are deterministically predictable based upon input values to the first device under test without knowing an initialization state of the first device under test;
determining which output values from the second device under test are deterministically predictable based upon input values to the second device under test without knowing an initialization state of the second device under test;
providing identical input values to the first device under test and to the second device under test; and
comparing first output values of the first device under test with second output values from the second device under test, wherein the first output values from the first device under test are deterministically predictable from the identical input values, wherein the second output values from the second device under test are deterministically predictable from the identical input values, and wherein differences in the first output values from the second output values indicate incorrect operation.

2. A method as in claim 1, wherein an input to the first device under test is tied to an input to the second device under test.

3. A method as in claim 1 wherein logic implementing the first device under test is identical in function to logic implementing the second device under test, but is configured so that there are timing differences between the first device under test and the second device under test.

4. A method as in claim 1 wherein logic implementing the first device under test is identical in function to logic implementing the second device under test, wherein logic implementing the first device under test is identical in function to logic implementing the second device under test, but is configured so that there are timing differences between the first device under test and the second device under test; wherein the timing differences arise are caused by activation or deactivation of one or more of the following functionalities:
pipelining;
caching;
queuing;
power optimizations;
dynamically controlled power optimizations;
parallelism in data fetching, processing or resource sharing.

5. A method as in claim 1, additionally including:
providing additional input values to the first device under test that are not identical to additional input values to the second device under test, wherein the additional input values to the first device under test and the additional input values to the second device under test are in addition to the identical input values provided to the first device under test and to the second device under test.

6. A method as in claim 1 wherein logic implementing the first device under test is implemented using hardware devices fabricated on an integrated circuit chip.

7. A method as in claim 1 wherein logic implementing the first device under test is implemented by an emulator.

8. A method as in claim 1 wherein logic implementing the first device under test is implemented by software running on a computing device.

9. A method as in claim 1 wherein the identical input values to the first device are chosen based on expected input to the first device under test during normal operation.

10. A method as in claim 1 wherein the identical input values to the first device are chosen based on providing a formal proof of correct operation.

11. A hardware verification system, comprising:
a first device under test;
a second device under test, the second device under test being logically identical to the first device under test;
an input generator that provides identical input values to the first device under test and to the second device under test; and
comparator that compares output values of the first device under test and the second device under test;
wherein verification system is controlled so that the comparator compares first output values from the first device under test that are deterministically predictable based upon input of the identical input values to the first device under test without knowing an initialization state of the first device under test with second output values from the second device under test are deterministically predictable based upon input of the identical input values to the second device under test without knowing an initialization state of the first second under test to verify operation of the first device under test; and,
wherein differences in the first output values from the second output values indicate incorrect operation.

12. A hardware verification system as in claim 11, wherein an input to the first device under test is tied to an input to the second device under test.

13. A hardware verification system as in claim 11 wherein logic implementing the first device under test is identical in function to logic implementing the second device under test, but is configured so that there are timing differences between the first device under test and the second device under test.

14. A hardware verification system as in claim 11 wherein logic implementing the first device under test is identical in function to logic implementing the second device under test, wherein logic implementing the first device under test is identical in function to logic implementing the second device under test, but is configured so that there are timing differences between the first device under test and the second device under test; wherein the timing differences arise are caused by activation or deactivation of one or more of the following functionalities:
pipelining;
caching;
queuing;
power optimizations;
dynamically controlled power optimizations;
parallelism in data fetching, processing or resource sharing.

15. A hardware verification system as in claim 11, wherein verification system is controlled so that additional input values to the first device under test that are not identical to additional input values to the second device under test, wherein the additional input values to the first device under test and the additional input values to the second device under test are in addition to the identical input values provided to the first device under test and to the second device under test.

16. A hardware verification system as in claim 11 wherein logic implementing the first device under test is implemented using one of the following:
hardware devices fabricated on an integrated circuit chip;
an emulator;
software running on a computing device.

17. A hardware verification system as in claim 11 wherein the identical input values to the first device are chosen based on expected input to the first device under test during normal operation.

18. A hardware verification system as in claim 11 wherein the identical input values to the first device are chosen based on providing a formal proof of correct operation.

19. A method for verifying a software design, comprising:
providing a first software-implemented device under test;
providing a second software-implemented device under test, the second software-implemented device under test being logically identical to the first software-implemented device under test;
determining which output values from the first software-implemented device under test are deterministically predictable based upon input values to the first software-implemented device under test without knowing an initialization state of the first software-implemented device under test;
determining which output values from the second software-implemented device under test are deterministically predictable based upon input values to the second software-implemented device under test without knowing an initialization state of the second software-implemented device under test;
providing identical input values to the first software-implemented device under test and to the second software-implemented device under test; and
comparing first output values of the first software-implemented device under test with second output values from the second software-implemented device under test, wherein the first output values from the first software-implemented device under test are deterministically predictable from the identical input values, wherein the second output values from the second software-implemented device under test are deterministically predictable from the identical input values, and wherein differences in the first output values from the second output values indicate incorrect operation.

20. A method as in claim 19, wherein logic implementing the first software-implemented device under test is identical in function to logic implementing the second software-implemented device under test, but is configured so that there are timing differences between the first software-implemented device under test and the second software-implemented device under test.
